(19) United States
(12) Patent Application Publication
(10) Pub. No.: US 2015/0249720 A1
(43) Pub. Date: Sep. 3, 2015

(54) IN-APP CONTENT CHANNEL

(71) Applicant: Airpush, Inc., Los Angeles, CA (US)

(72) Inventor: Asher Delug, Los Angeles, CA (US)

(73) Assignee: Airpush, Inc., Los Angeles, CA (US)

(21) Appl. No.: 14/219,368

(22) Filed: Mar. 19, 2014

Related U.S. Application Data
(60) Provisional application No. 61/947,375, filed on Mar. 3, 2014.

(51) Int. Cl. H04L 29/08

(52) U.S. Cl. CPC H04L 67/28; H04L 67/10

(57) ABSTRACT

Among other disclosed subject matter, a method for providing content through a mobile device is disclosed. The method includes receiving a user request to access a content channel associated with a content channel Software Development Kit (SDK), where the content channel SDK is embedded within an application executing on the mobile device. The method includes gathering the content to be provided through the content channel using the content channel SDK. The method further includes displaying the gathered content through the content channel on the mobile device.

### PRIORITY CLAIM

This application claims the benefit of U.S. Provisional Patent Application No. 61/947,375, entitled “IN-APP CONTENT CHANNEL”, filed on Mar. 3, 2014, which is incorporated by reference herein in its entirety.

### FIELD

The present invention generally relates to content delivery and more specifically to delivery of content through a mobile device application.

### BACKGROUND

It is well known that mobile phones are becoming increasingly sophisticated, with many supporting multiple mobile applications to be downloaded and installed. Examples of such mobile applications include, but are not limited to, mobile based games, productivity applications, and e-commerce applications. The mobile applications are divided into free mobile applications and paid mobile applications. Most of the free mobile applications, including some of the paid mobile applications, generate revenue by displaying advertisements (“ad”) and other sponsored content to users of the mobile applications. Further, in many instances, increase in such revenue is critical to the continued support and development of the mobile applications. Therefore, there exists a continued need to increase the revenue generation potential of these various mobile applications.

### BRIEF DESCRIPTION OF DRAWINGS

These and other objects, features and characteristics of the disclosed technology will become more apparent to those skilled in the art from a study of the following detailed description in conjunction with the appended claims and drawings, all of which form a part of this specification. In the drawings:

FIG. 1 provides a brief, general description of a representative environment in which the disclosed technology can be implemented;

FIG. 2 is a flow diagram illustrating a method for providing content through a content channel associated with a content channel SDK embedded within an application;

FIG. 3 is a flow diagram illustrating a method for providing content through a content channel associated with a content channel SDK embedded within an application;

FIG. 4 is a flow diagram illustrating a method for configuring and installing the configured SDK in an application;

FIG. 5A is a block diagram providing an illustrative example of a content channel provided as a menu-item within a gaming application;

FIG. 5B is a block diagram providing an illustrative example of a content channel provided as an overlay-item within a displayed entertainment news article;

FIG. 5C is a block diagram providing an illustrative example of notification items provided through the notification tray of the mobile device, which can be clicked to invoke an associated content channel;

FIG. 6A is a block diagram providing an illustrative example of a branded music content channel that can be accessed from within a given application;

FIG. 6B is a block diagram providing an illustrative example of an unbranded game content channel that can be accessed from within a given application; and

FIG. 7 is a block diagram of a computer system as may be used to implement features of some embodiments of the disclosed technology.

The headings provided herein are for convenience only and do not necessarily affect the scope or meaning of the claimed invention.

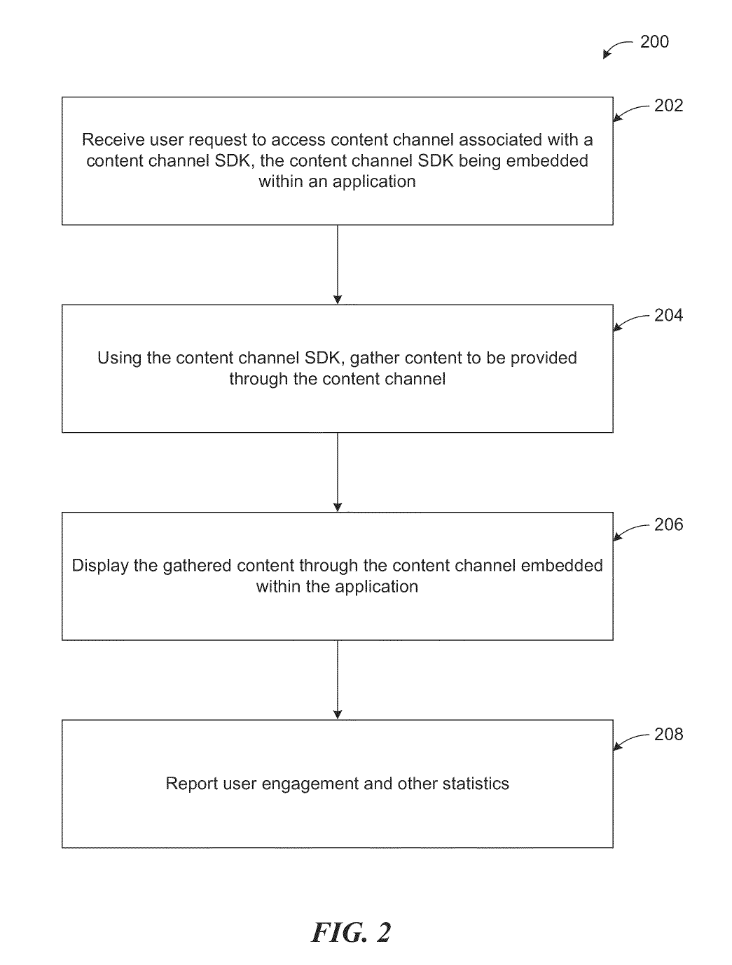

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 204 is first introduced and discussed with respect to FIG. 2).

### DETAILED DESCRIPTION

Technology is disclosed for delivering content through a mobile device application (“the technology”). The technology receives a user request to access a content channel associated with a content channel Software Development Kit (SDK). The content channel SDK is embedded within an application executing on the mobile device. The technology gathers content to be provided through the content channel using the content channel SDK. The technology displays the gathered content through the content channel on the mobile device.

Various examples of the technology (“disclosed technology”) will now be described. The following description provides specific details for a thorough understanding and enabling description of these examples. One skilled in the relevant art will understand, however, that the technology may be practiced without many of these details. Likewise, one skilled in the relevant art will also understand that the technology can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the technology. Indeed, certain terms may even be emphasized below; however, any terminology intended to be interpreted in any restricted manner will be overtly and specifically defined as such in this Detailed Description section.

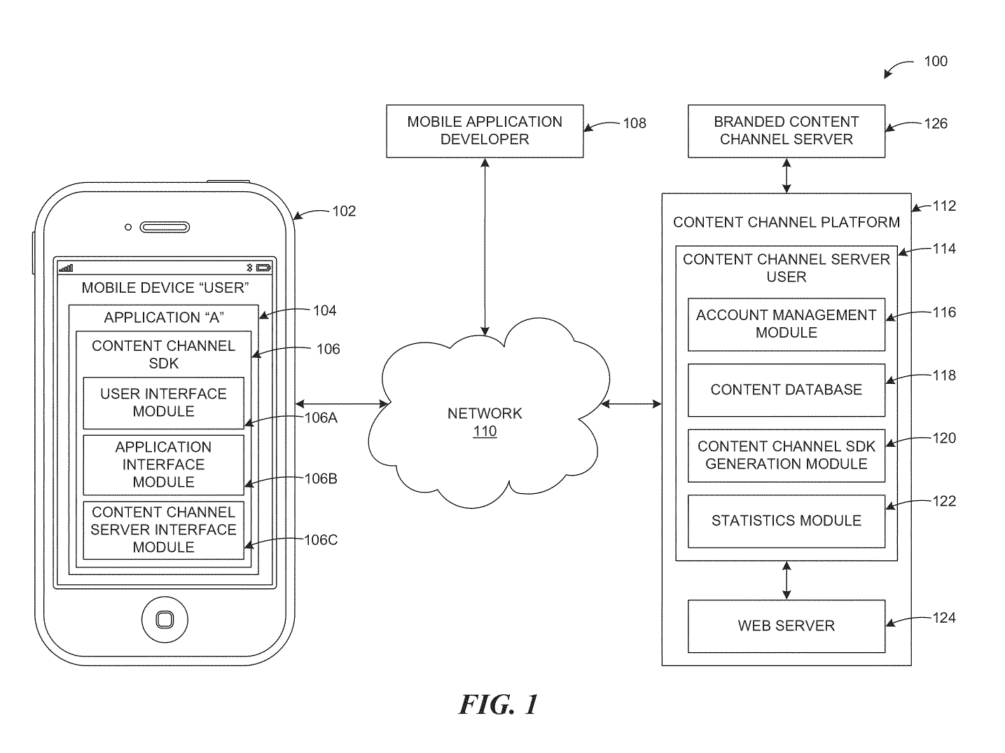

FIG. 1 and the following discussion provide a brief, general description of a representative environment in which the disclosed technology can be implemented. Although not required, aspects of the technology may be described below in the general context of computer-executable instructions, such as routines executed by a general-purpose data processing device (e.g., a server computer or a personal computer). Those skilled in the relevant art will appreciate that the technology can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are used interchangeably herein, and may refer to any of the above devices and systems.

While aspects of the technology, such as certain functions, are described as being performed exclusively on a single device, the technology can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the technology may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the technology may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

In the representative environment shown in FIG. 1, a user may use a personal computing device (e.g., a phone 102, a personal computer, etc.) to communicate with a network 110. The term “phone,” as used herein, may be a smart phone (e.g., an Apple iPhone®), a personal digital assistant (PDA), a portable media player (e.g., an IPod Touch®), or any other device having communication capability to connect to the network 110. In one example, the phone 102 connects using one or more cellular transceivers or base station antennas (in cellular implementations), access points, terminal adapters, routers or modems (in IP-based telecommunications implementations), or combinations of the foregoing (in converged network embodiments).

In some instances, the network 110 is the Internet, allowing the phone 102 (with, for example, WiFi capability) or the personal computer to access web content offered through various web servers 124. In some instances, especially where the phone 102 is used to access web content through the network 110 (e.g., when a 3G or an LTE service of the phone 102 is used to connect to the network 110), the network 110 may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

In some instances, a user utilizes one or more applications installed on the phone 102 (“mobile device”) to connect to one or more web servers 124 and other associated content servers 112 through the network 110. In one instance, when a mobile user requests to access content associated with an application 104, the application 104 directs the request to, for example, a content platform 112 that includes a content server 114 with a content database 118 and a web server 124, which operate together to provide access to the content stored in content database 118 as requested by the mobile user.

In some embodiments, a content channel software development kit (“SDK”) 106 is embedded within an application 104 to enable the application 104 to connect and access content stored in a content channel platform 112. When a mobile user requests to access content, the SDK 106, embedded within the application 104, receives and directs the request to, for example, a content platform 112 and provides any received content from the content platform 112 to the mobile user.

The SDK provides a layered framework that defines a plurality of interacting software layers for communicating data and commands between a user interface module and a communications stack that enables communication to a remote server, e.g., a content channel platform 112. The SDK includes a number of pre-coded API function modules for implementing various user interface functions and remote server interface functions. The SDK further includes a number of pre-coded function mapping instruction sets to map function calls from the user interface API function modules to the communications stack to communicate user request to remote servers, e.g., a content channel platform 112.

The layered framework may include a user interface module 106A (or simply “a user interface API layer”), an application interface module 106E (or simply “an application API layer”), and a content channel server interface module 1060 (or simply “communication layer”). The application interface module 106B includes APIs that allow the SDK to be embedded within a given application and be provided to the user when the given application is invoked. The various API function modules are identified and exposed in each of the layer according to a simplified command syntax associated with the SDK.

In some embodiments, the SDK 106 provides one or more content channels that allow a mobile device user to access content from the content channel platform 112 which are associated with a given content channel. In embodiments, the content associated with a content channel can be a predefined subset of content accessible through the content channel platform 112. In embodiments, the content channel platform 112 can identify the subset of content associated with the content channel by applying a content filter associated with the content channel. In embodiments, the SDK 106 includes APIs for communicating with the content channel platform 112 to provide the content channel being accessed. In embodiments, the SDK 106 further includes APIs for communicating with the content channel platform 112 to provide other user requests associated with the content displayed through the content channel.

In some embodiments, a given content channel can be branded content channel, an unbranded content channel, or a combination of both, where the source of the content for a branded content channel is provided by a third-party who originates the content. In embodiments, the content channel platform 112 provides access for branded content channel by accessing data sources, e.g., branded content channel server 126, maintained by third parties who originate the content.

For example, a branded music content channel can be a Rolling Stone® music channel that sources its content from the other media product of the Rolling Stone®, such as their magazine that includes content such as music reviews, movie reviews, musical artists, free MP3s, photos of pop culture entertainers, etc. On the other hand, an unbranded content channel provides content that is sourced from other content originators and formatted independently of any original content formatting.

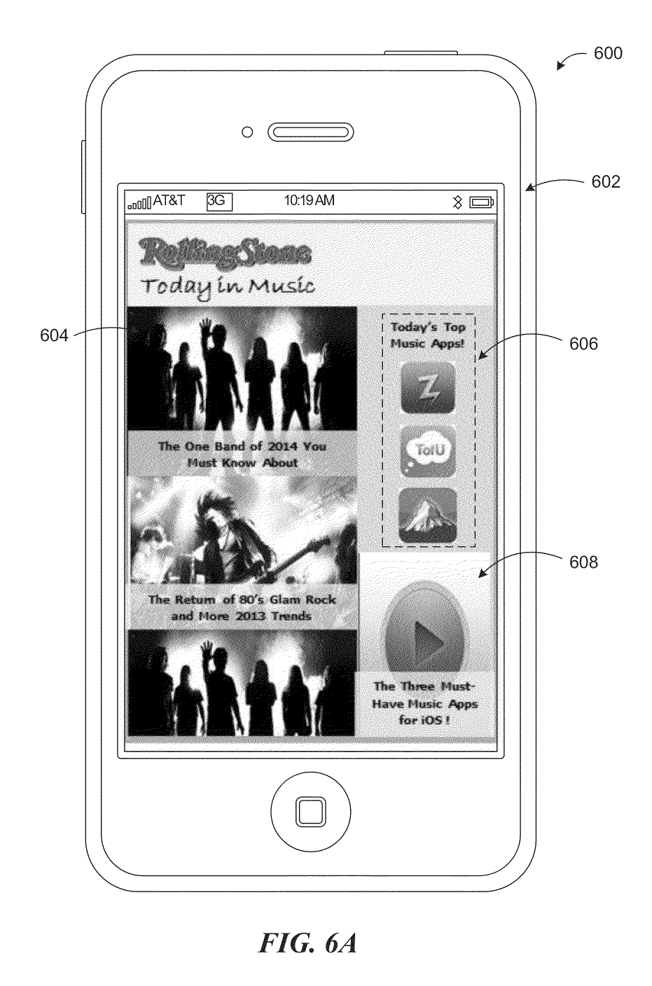

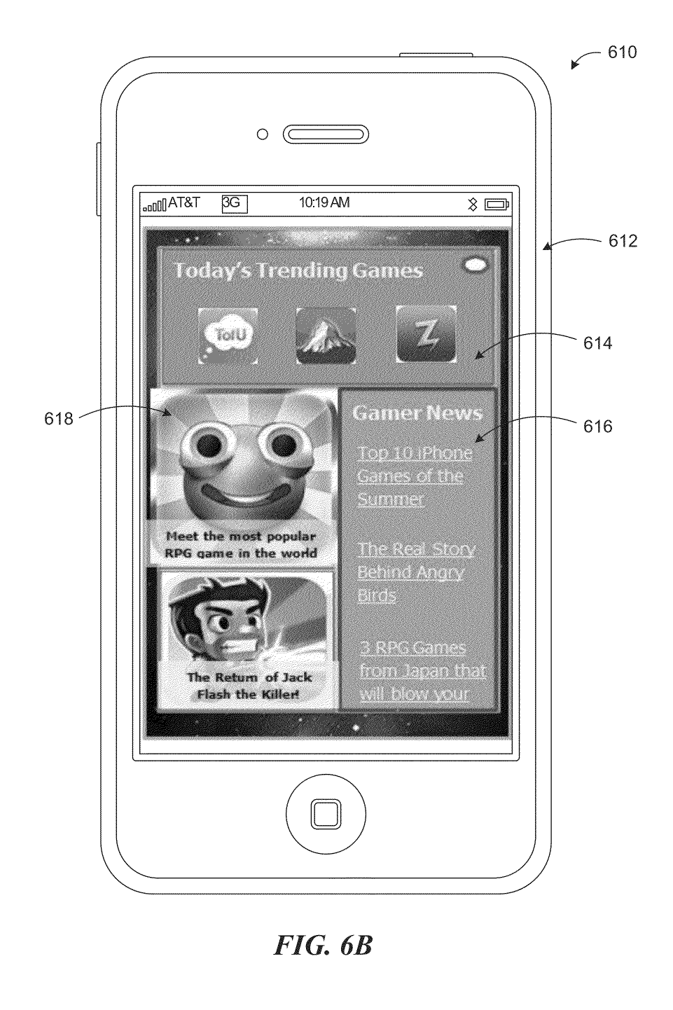

Turning briefly to FIG. 6A, FIG. 6A is a block diagram 600 providing an illustrative example of a branded music content channel 602 that can be accessed from within a given application 104. The branded music content channel 602 is a Rolling Stone® music channel that provides music related articles (using a news content widget 604), which are sourced from the Rolling Stone® magazine. Further, the branded music content channel 602 provides content widget 606 that provides the list of top trending music apps 606 as icons and content widget 608 that provides information regarding the best music apps 608.

The content widgets are stand-alone applications that can be embedded into the content channels. The content widgets allow to turn content into dynamic web apps that can be shared on websites where the code can be installed. For example, a “Weather Report Widget” could report today's weather by accessing data directly from an associated weather channel database or through an aggregated data source of the content channel platform 112. Additional details regarding the content widgets and the various categories of widgets that can be embedded within the content channel are provided in detail in later discussion.

Returning to FIG. 1, in one example, an unbranded content channel can be a generic music content channel that sources a portion of its data/content from various content providers, such as Rolling Stone®, Billboard®, etc. For instance, a poll data relating to popularity of various recent album releases can be utilized to create a list of top ten new songs and provide the list through the generic music content channel. In embodiments, the name of the unbranded content channel embedded within an application through the SDK can be customized within each application. For example, an unbranded music content channel, called generically as “Music channel”, can be renamed as “Music Insider” by the developer of the application 104 and presented to the user of the application.

Briefly turning to FIG. 6B, FIG. 6B is a block diagram 610 providing an illustrative example of an unbranded game content channel 612 that can be accessed from within a given application 104. The unbranded game content channel 612 provides video game related news articles using a news content widget 616 that sources its content from other third party providers, a list of top trending game apps as icons through trending apps content widget 614 and a featured app through featured app content widget 618. The layout of the various widgets within the content channel 612 can be based on sample templates or can be customized. Additional details regarding the content widgets, the various categories of widgets that can be embedded within the content channel and setting the layout of the content widgets within a content channel are provided in detail in later discussion.

Returning to FIG. 1, in embodiments, the content channel provided through an SDK 106 can be customized based on the type of application 104 within which the SDK 106 is embedded. For instance, the content channels can include a content channel providing video games related content, a content channel providing music related content, a content channel providing wallpapers, a content channel providing utilities, a content channel providing entertainment related content, etc. Based on the genre of the application 104 within which the content channel is provided (through the SDK 106), the provided content channel can be one that belongs to the same/similar genre as that of the application 104. For example, a free music app (such as Pandora®) can include the music content related content channel.

In embodiments, the various branded content channels can each include preferred content partners for sourcing the content for the channel. For example, a content channel providing video games related content can include EA®, Edge®, GamePro®, etc., as partners while a content channel providing music related content can include Rolling Stone®, Vibe®, Billboard®, etc., as partners. Similarly, a content channel providing wallpapers can include Getty®, etc., as partner while a content channel providing entertainment can include TMZ®, People®, etc., as partners.

In embodiments, the SDK 106 provides a content channel as a menu-item within the application 104, where the content channel can be invoked by clicking on the displayed menu-item. In embodiments, the SDK 106 includes application interface module 106B which includes APIs that allow a developer 108 to embed the content channel of the SDK 106 within the application 104 as, for example, a menu-item within the application 104.

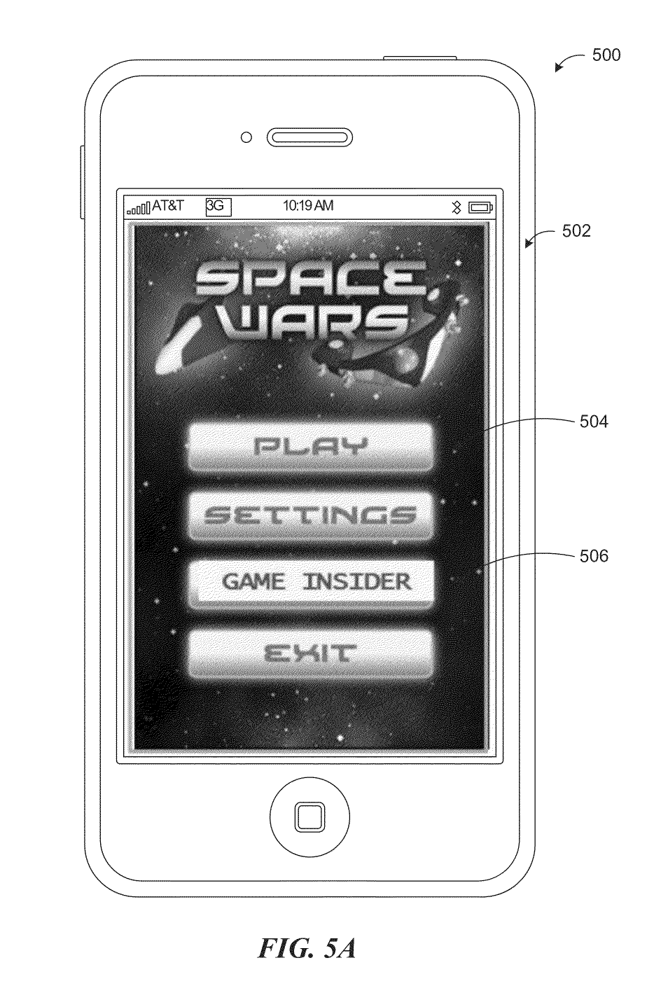

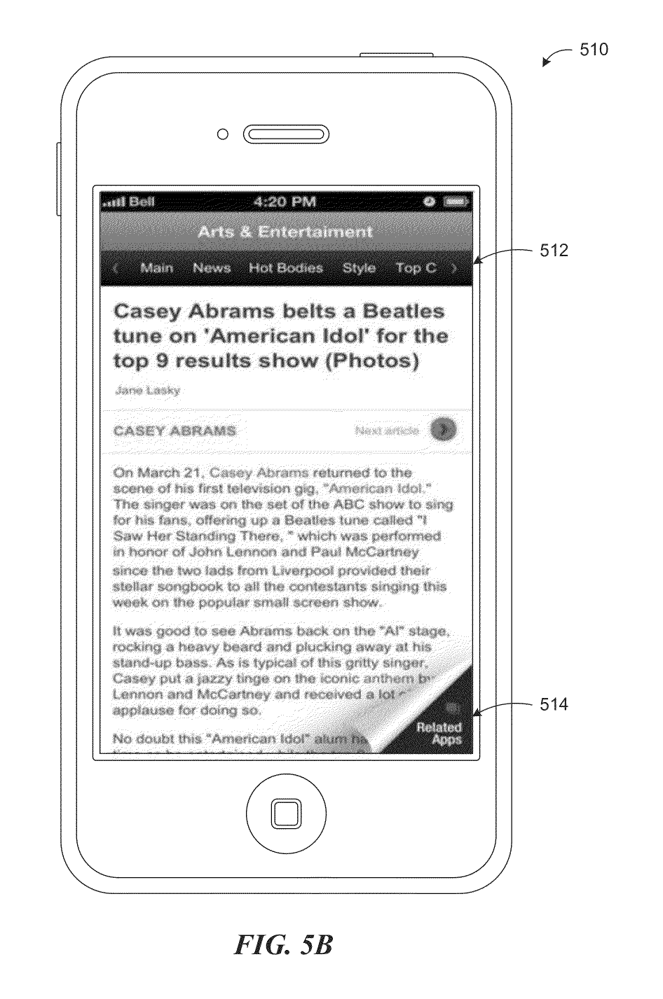

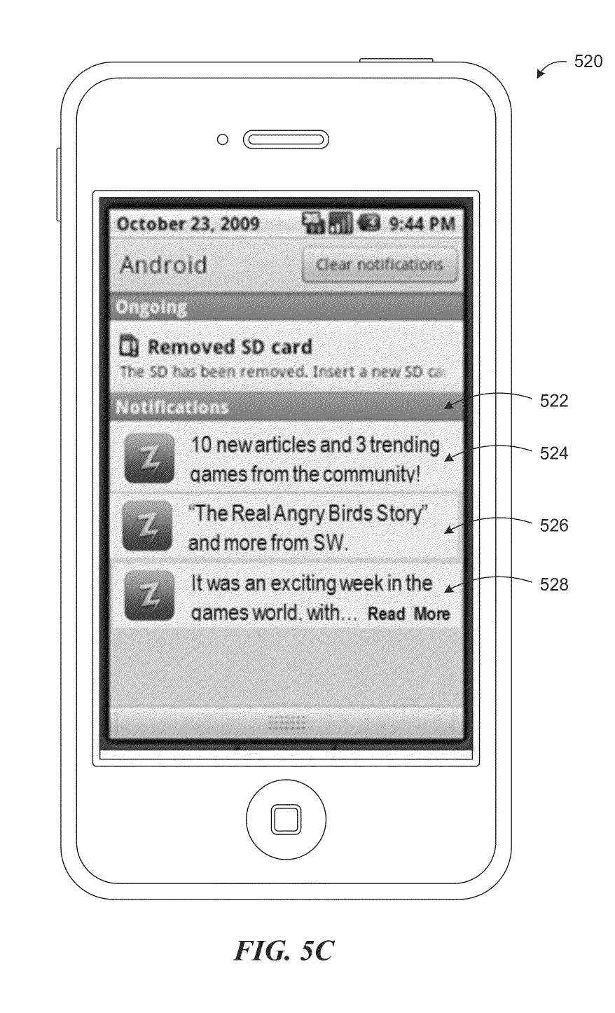

Turning briefly to FIG. 5A, FIG. 5A is a block diagram 500 providing an illustrative example of a content channel 506 provided as a menu-item within a gaming application 504. The menu-items of the gaming application 504 includes various items that allow a user to play the game, adjust the settings of the game, exit the game, etc. Further, the menu-items include the content channel “Game Insider” 506 of the SDK 106, which is an unbranded gaming channel that provides video game related news as discussed earlier. By clicking on the content channel “Game Insider” 506, a user can access the contents provided through an unbranded game content channel, for example, the unbranded game content channel 612 illustrated in FIG. 6B.

Returning to FIG. 1, in embodiments, the SDK 106 provides access to the content channel as an overlay item within the displayed content of the application 104, where the content channel can be invoked by clicking on the displayed overlay item. An overlay item is a semi-transparent overlay across another displayed content, typically covering a small portion of the other displayed content, where the overlay item is displayed in conjunction with another displayed content. The overlay item can be a scroll, a ticker, or a watermark image.

Turning briefly to FIG. 5B, FIG. 5B is a block diagram 510 providing an illustrative example of a content channel 514 provided as an overlay-item within a displayed entertainment news article 512. By clicking on the overlay-item “Related Apps” 512, a user can access a list of “Arts and Entertainment” related apps provided through an entertainment related content channel, for example, the branded music content channel 602 illustrated in FIG. 6A which includes a list of top music apps 606.

Returning to FIG. 1, in embodiments, the SDK 106 provides access to the content channel as an in-app feature, where the developer 108 of the application 104 can utilize an exposed API from the application interface module 106B to tie an in-app feature with the content channel of the SDK 106. A user of the application 104 can access the content channel by utilizing the in-app feature. The in-app feature can include any feature of the application 104 that the user can interact with. For example, in a first-shooter gaming application, the in-app feature can be a special target the gamer can shoot to invoke the content channel. In another example, the gamer can be provided access to a special button that invokes the content channel when the gamer reaches a certain milestone within the game.

In embodiments, the SDK 106 provides access to the content channel as an interstitial content, where the interstitial content can be clicked to access the associated content channel. The interstitial content can be generally provided as a full-page content at specific temporal points within the relative execution time-scale of the application 104. For example, the interstitial content can display “Game Insider” banner in a full-page display before the gamer starts a new level in a gaming application, where the “Game Insider” banner provides access to an unbranded gaming content channel associated with an SDK 106 embedded within the gaming application.

In embodiments, the SDK 106 provides access to the content channel as a push notification item in the notification tray of the computing device 102, where the content channel can be invoked by accessing the associated push notification item. In embodiments, the SDK 106 provides push notification items that are fully complaint with the usage terms associated with the use of the notification tray. For example, many mobile operating systems (“OS”), e.g., Android® OS, restrict the use of the notification tray to send notification items that are non-commercial in nature. The SDK 106 utilizes “teaser” content related to news, blog posts, other trending content from the content channel, etc., as push notification items to engage the user to invoke the content channel for accessing the content associated with the “teaser” content.

Briefly turning to FIG. 5C, FIG. 5C is a block diagram 520 providing an illustrative example of notification items 524-528 provided through the notification tray 522 of the mobile device, which can be clicked to invoke an associated content channel. Each notification item 524-528 in the notification tray 522 can be associated with a particular content channel, where the various content channels can in turn be associated with particular SDK 106 embedded within a corresponding application installed on the mobile device.

For instance, the notification item 522 regarding new articles and top games can be clicked to access an unbranded game content channel associated with an SDK 106 embedded in application “A” while the notification item 524 regarding the Angry Bird® game can be clicked to access another unbranded game content channel associated with an SDK 106 embedded in application “B”. The two applications “A” and “B” can be both gaming applications with either same or independent developers/publishers, where the game content channels associated with the applications “A” and “B” can be customized channels with distinct content from each other.

Returning to FIG. 1, in embodiments, the content channel platform 112 provides various types of content widgets that can be used to customize the content provided through a content channel. For instance, in the above discussed sample unbranded game content channel 612, the content of the game content channel 612 is customized to include a gaming related news widget, a top trending app widget, a featured app widget, etc.

In embodiments, the content channel platform 112 provides a “Trending Apps” widget that provides a scrollable display of trending apps as icons in a relevant category, e.g., music related apps, etc., where the apps can be accessed by clicking on the provided icons. The widget can be customized to include content (i.e. the list of trending apps) that is provided by a third party or available through an aggregated data source accessible through the content channel platform 112.

In embodiments, the application developer 108 of the application 104 within which the content channel is provided through can customize the widget content (when incorporating the “Trending Apps” widget within the content channel) to include their own trending apps, allowing for cross-promotion of their other applications through their current application 104. The term application developer 108 includes application publishers and is generically used to refer to any person or entity that can customize/elect to embed the SDK 106 (and any associated content) within the application 104, such as a given application's publisher. The term, therefore, should not be construed to limit the application developer 108 to just those entities who developed the application 104 within which the SDK 106 is embedded.

In embodiments, the content channel platform 112 provides a “New Apps” widget that provides a scrollable display of new apps as icons in the relevant category, e.g., music related apps, etc., where the apps can be accessed by clicking on the provided icons. Similar to the “Trending Apps”, the “New Apps” can be customized to include content (i.e. the list of new apps) that is provided by a third party or available through an aggregated data source accessible through the content channel platform 112. In embodiments, the application developer 108 of the application 104 within which the content channel is provided through can customize the widget content to include their own new apps, allowing for cross-promotion of their other new applications through their current application 104.

In embodiments, the content channel platform 112 provides a “Featured App” widget that displays a single app as an icon with associated text, where the apps can be accessed by clicking on the provided icon. Similar to the “Trending Apps”, the “Featured App” can be customized to include content (i.e. the choice of the featured app and any associated text) that is provided by a third party or available through an aggregated data source accessible through the content channel platform 112. In embodiments, the application developer 108 of the application 104 within which the content channel is provided through can customize the widget content to include their own featured app, allowing for cross-promotion of their other applications through their current application 104.

In embodiments, the content channel platform 112 provides a “App Collections” widget that provides a collection of related apps as icons, where the apps can be accessed by clicking on the provided icons. Similar to the “Trending Apps”, the “App Collections” can be customized to include content (i.e. the list of applications) that is provided by a third party or available through an aggregated data source accessible through the content channel platform 112. In embodiments, the application developer 108 of the application 104 within which the content channel is provided through can customize the widget content to include their own featured app, allowing for cross-promotion of their other applications through their current application 104.

In embodiments, the content channel platform 112 provides a “News” widget that provides a list of relevant headlines in the relevant category, e.g., music related headlines, where the articles associated with the headlines can be accessed by clicking on the listed headline. Similar to the “Trending Apps”, the “News” widget can be customized to include content (i.e. the headlines) that is provided by a third party or available through an aggregated data source accessible through the content channel platform 112.

In embodiments, the application developer 108 of the application 104 within which the content channel is provided through can customize the widget content to include their own featured headlines, including blogs published by the developers, to allow for cross-promotion of their other content and products through their current application 104. In embodiments, the “News” widget allows a given user to share the various content, e.g., headlines, provided through the widget, with the given user's social network. In some embodiments, the “News” widget includes social network sharing features that utilizes the given user's social network access details to directly share any content, e.g., headlines, which are selected by the given user with the given user's social network.

In embodiments, the content channel platform 112 provides a “Featured Article” widget that provides access to a single article in a relevant category, e.g., a music related article, described with a combination of teaser headline and/or image, where the article associated with the teaser description can be accessed by clicking on the description/image. Similar to the “News” widget, the “Featured Article” widget can be customized to include content (i.e. accessible article) that is provided by a third party or available through an aggregated data source accessible through the content channel platform 112.

In embodiments, the application developer 108 of the application 104 within which the content channel is provided through can customize the widget content to include their own featured article, including blogs published by the application developers 108, to allow for cross-promotion of their other content and products through their current application 104. Further, similar to the “News” widget, the “Featured Article” widget allows a given user to share the various content, e.g., featured content, provided through the widget, with the given user's social network.

In embodiments, the content channel platform 112 provides a “Poll” widget that provides an interactive poll on one or more question which user can vote for and receive the results in real-time. Similar to the “News” widget, the “Poll” widget can be customized to include content (i.e. poll questions) that is provided by a third party or generated through an aggregated data source accessible through the content channel platform 112. In embodiments, the application developer 108 of the application 104 within which the content channel is provided through can customize the widget content to include their own poll questions to allow. Further, similar to the “News” widget, the “Poll” widget allows a given user to share the poll questions and results with the given user's social network.

In embodiments, the content channel platform 112 provides a “Poll” widget that provides an interactive poll on one or more question which user can vote for and receive the results in real-time. Similar to the “News” widget, the “Poll” widget can be customized to include content (i.e. poll questions) that is provided by a third party or generated through an aggregated data source accessible through the content channel platform 112. In embodiments, the application developer 108 of the application 104 within which the content channel is provided through can customize the widget content to include their own poll questions. Further, similar to the “News” widget, the “Poll” widget allows a given user to share the poll questions and results with the given user's social network.

In embodiments, the content channel platform 112 provides a “Videos” widget that provides access to one or more videos in a relevant category, e.g., music videos of popular songs for incorporating in music genre applications. Similar to the “News” widget, the “Videos” widget can be customized to include content (i.e. videos) that is provided by a third party or available through an aggregated data source of curated videos that are accessible through the content channel platform 112. In embodiments, the application developer 108 of the application 104 within which the content channel is provided through can customize the widget content to include their videos. Further, similar to the “News” widget, the “Videos” widget allows a given user to share the videos with the given user's social network.

In embodiments, the content channel platform 112 provides a “Email List Collection” widget that enables a user to provide their personal information, such as email address, name, zip code, etc. The collected information can be maintained as a master list in the content channel platform 112 and be utilized by the content channel platform 112 and/or the application developer 104 for various purposes, including user identification, content targeting, etc.

In embodiments, the content channel platform 112 provides a “Deals/Coupons and Passbook” widget that provides offers and/or coupons from various brands, local businesses, etc. In embodiments, the application developer 108 of the application 104 within which the content channel is provided through can customize the widget content to include their own offers to cross promote their other products or provide discounts for in-app purchases within application 104. Further, similar to the “News” widget, the “Deals/Coupons and Passbook” widget allows a given user to share the deals/coupons and other received offers with the given user's social network.

In embodiments, the content channel platform 112 provides a “Galley” widget that provides access to a gallery of images/photos with captions, where such a widget can be utilizes to convey a message or be utilized by the application developer 104 to offer a tour (e.g., “Take a tour”) of a promoted application/content. Further, similar to the “News” widget, the “Gallery” widget allows a given user to share the images/photos with the given user's social network. In embodiments, the content channel platform 112 provides a “Event” widget that enables a user to RSVP to events promoted through the content channel and/or add calendar events/reminders of the events. Further, similar to the “News” widget, the “Event” widget allows a given user to share the details of the events with the given user's social network and allow RSPVs to the event from entities in the given user's social network.

As discussed earlier, in embodiments, the content and the layout of the content provided through a content channel can be customized. In embodiments, the content channel SDK generation module 120 can be utilized to customize a content channel and generate an SDK 106 with the content channel, where the SDK 106 with the custom content channel can be embedded within an application. For instance, a developer/publisher 108 of the application 104 can generate an SDK 106 with a customized content channel by using the generation module 120 and embed the SDK 106 within their application 104 before distributing the application 104.

In embodiments, the generation module 120 generates the appropriate SDK 106 based on the OS upon which the application 104 executes. For example, if the application 104 is written for the Andriod® OS, the generation module 120 generates an appropriate version of the SDK 106 that works with applications written for Andriod® OS. In embodiments, the generation module 120 uses the name of the application within which the SDK 106 is embedded to detect the various parameters of the applications, e.g., the application platform, the genre of the application, etc., to customize the SDK 106 and its associated content channel. The generation module 120 can utilize a data source, e.g., the Apple® iTunes® store, to gather the various parameters of the applications.

In embodiments, the developer/publisher 108 of the application 104 can use the generation module 120 to select the type of content channel, the layout of the content channel, the access points for the content channels within the application, any access point related push notification configuration, etc., and generate a SDK 106 incorporating those selections. In embodiments, the generation module 120 can use the genre and other parameters of the application within which the SDK 106 is being embedded to automatically select a content channel relevant to the application, the content widgets to provide within the content channel, the layout of the various content widgets within the content channel, a default set of access points for the content channels, a default notification strategy, etc.

For example, if the application is a music app, e.g., Pandora®, the generation module 120 can elect an unbranded music channel to provide as the content channel within the app given the likelihood of a strong user interest in accessing content related to music through a music app. The generation module 120 can utilize default content widgets and layouts for the widgets as configured in the content platform 112 for the content channel. Further, the generation module 120 can utilize default push notification configuration such as frequency of notifications, timeframe within which to target active/inactive users, format of the push notifications, etc.

In embodiments, the developer/publisher 108 of the application 104 can use the generation module 120 to override the type of content channel automatically selected by the generation module 120 and elect their own content channel from the available channels (or create their own custom content channel with the various content widgets). In embodiments, the developer/publisher of the application 104 can customize the layout of the content channel and the formatting of the content provided the content channel. The formatting of the content can include adjusting the design elements of the displayed content, e.g., the font types, colors, rounded/square corners for icons, etc.

In embodiments, the developer/publisher 108 of the application 104 can customize the content of the content widgets by providing the names and associated details of applications, links to blogs, news articles, etc., which the developer/publisher 108 of the application 104 wants to cross-promote within the application 104. In embodiments, the developer/publisher 108 of the application 104 can customize the push notification configuration such as frequency of notifications to be sent within a timeframe, the profile of users to target (e.g., target only users inactive over a given time period), format of the push notifications, etc.

In embodiments, the content platform 112 uses the account management module 116 to store and manage the various elections and content provided by the developer/publisher 108 of the application 104 in association with an account accessible by the developer/publisher 108. In embodiments, the content platform 112 uses a statistics module 122 to monitor and aggregate various statistics related to the usage/interaction of the users with the content provided through the content channel accessible through the application 104.

For instance, the statistics monitored can include any article accessed by the users of the application, the number of users who accessed a given article, the time spent on the given article, the number of downloads of any cross-promoted applications, etc. In embodiments, the content platform 112 utilizes the gathered statistics to infer user interests and dynamically change the content provide through the content channel to better reflect the inferred user interest. Any well-known machine-learning algorithm could be used to perform user interest inference.

Turning now to FIG. 2, FIG. 2 is a flow diagram illustrating a method 200 for providing content through a content channel associated with a content channel SDK 106 embedded within an application. In various embodiments, the method 200 may be executed in a computing device, e.g., mobile computing device 102 of FIG. 1. It is understood that this is one embodiment of an illustrative method, and that other variations to the method, in accordance with various techniques discussed above in this document or in accordance with variations contemplated by persons of ordinary skill in the art, are also included herein.

The method 200 starts at block 202. At block 202, the method 200 receives user request to access content channel associated with a content channel SDK 106, where the content channel SDK 106 is embedded within the application 104. At block 204, the method 200 uses the content channel SDK to gather content to be provided through the content channel. As discussed above, the content channel SDK 106 includes communication layers that can interface with the content channel platform 112 to access any request content.

At block 206, the method 200 displays the gathered content through the content channel embedded within the application. At block 208, the method 200 collects and reports user engagement and other statistics related to interaction of a given user with the displayed content. As discussed earlier, the user engagement statistics can include the amount of time a user spent on a given displayed article, etc.

In some instances, the reported statistics are collected and aggregated by the content platform 112 for the developer/publisher 108 of the application. After executing block 208, the method 200 returns. Those skilled in the art will appreciate that the logic illustrated in FIG. 2 and described above, and in each of the flow diagrams discussed below, may be altered in various ways. For example, the order of the logic may be rearranged, substeps may be performed in parallel, illustrated logic may be omitted, other logic may be included, etc.

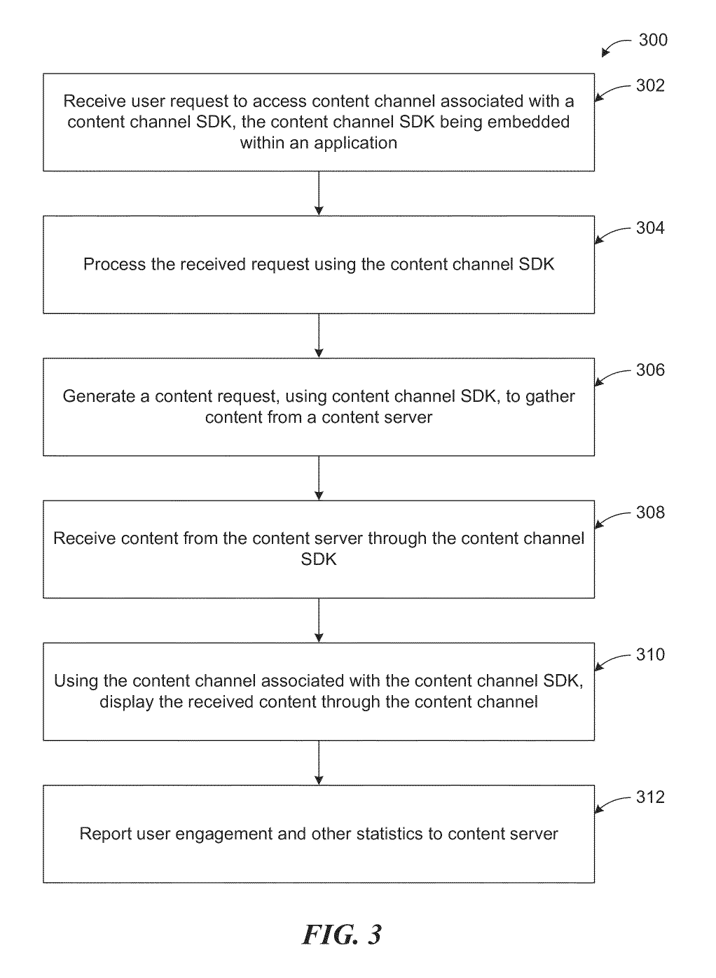

Turning now to FIG. 3, FIG. 3 is a flow diagram illustrating a method 300 for providing content through a content channel associated with a content channel SDK 106 embedded within an application. In various embodiments, the method 300 may be executed in a computing device, e.g., mobile computing device 102 of FIG. 1. The method 300 starts at block 302. At block 302, the method 300 receives user request to access content channel associated with a content channel SDK, where the content channel SDK 106 is embedded within an application.

At block 304, the method 300 processes the received request using the content channel SDK. At block 306, the method 300 generates a content request using the content channel SDK 106 to gather content from a content server. At block 308, the method 300 receives content from the content platform 112 through the content channel SDK 106. At block 310, the method 300 uses the content channel associated with the content channel SDK 106 to display the received content through the content channel. At block 312, the method 300 collects and reports any user engagement and other statistics to the content platform 112. After executing block 312, the method 300 returns.

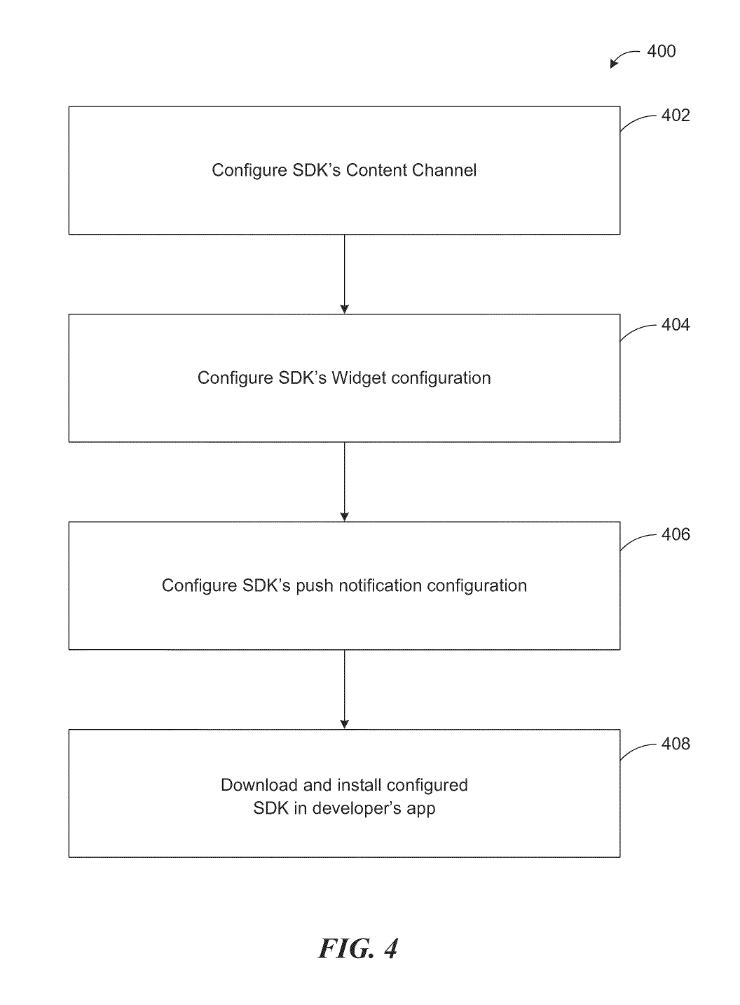

Turning now to FIG. 4, FIG. 4 is a flow diagram illustrating a method 400 for configuring and installing the configured SDK 106 in an application. In various embodiments, the method 400 may be executed in a computing environment, e.g., content channel platform 112 of FIG. 1. The method 400 starts at block 402. At block 402, the method 400 configures a content channel of a SDK 106. As discussed above, the content channel can be configured based on the genre and other parameters of the application within which the SDK 106 is being embedded in.

At block 404, the method 400 configures the layout configuration of one or more widgets provided through the content channel. As discussed above, the layout configuration can one of the one or more default configurations available through the content platform 112. At block 406, the method configures the push notification configuration of the access points used by the SDK 106 to enable a given user to invoke and access the content channel associated with the SDK 106. At block 408, the method downloads and installs the configured SDK 106 in a developer's application. The installing can include any hooking up of the APIs of the SDK 106 with the software code of the developer application within which the SDK 106 is being embedded and compiling (as needed) the code.

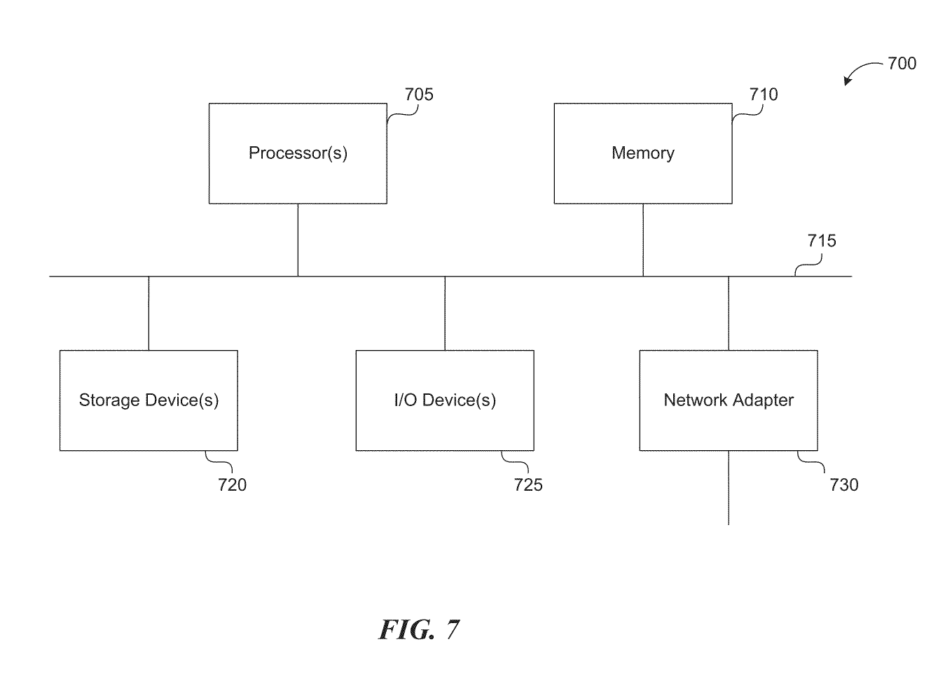

FIG. 7 is a block diagram of a computer system as may be used to implement features of some embodiments of the disclosed technology. The computing system 700 may include one or more central processing units (“processors”) 705, memory 710, input/output devices 725 (e.g., keyboard and pointing devices, display devices), storage devices 720 (e.g., disk drives), and network adapters 730 (e.g., network interfaces) that are connected to an interconnect 715. The interconnect 715 is illustrated as an abstraction that represents any one or more separate physical buses, point to point connections, or both connected by appropriate bridges, adapters, or controllers. The interconnect 715, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The memory 710 and storage devices 720 are computer-readable storage media that may store instructions that implement at least portions of the described technology. In addition, the data structures and message structures may be stored or transmitted via a data transmission medium, such as a signal on a communications link. Various communications links may be used, such as the Internet, a local area network, a wide area network, or a point-to-point dial-up connection. Thus, computer readable media can include computer-readable storage media (e.g., “non transitory” media) and computer-readable transmission media.

The instructions stored in memory 710 can be implemented as software and/or firmware to program the processor(s) 705 to carry out actions described above. In some embodiments, such software or firmware may be initially provided to the processing system 700 by downloading it from a remote system through the computing system 700 (e.g., via network adapter 730). The technology introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Unless the context clearly requires otherwise, throughout the description and the claims, the words “comprise,” “comprising,” “including,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof.

Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order.

Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein.

As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for.”) Accordingly, the applicant reserves the right to add additional claims after filing the application to pursue such additional claim forms for other aspects of the invention.

We claim:

1. A method for providing content through a mobile device, the method comprising:
receiving a user request to access a content channel associated with a content channel Software Development Kit (SDK), the content channel SDK being embedded within an application executing on the mobile device;
gathering, using the content channel SDK, the content to be provided through the content channel; and
displaying the gathered content through the content channel on the mobile device.

2. The method of claim 1, wherein the user request to access the content channel is provided by accessing a menu item within a menu of the application.

3. The method of claim 1, wherein the user request to access the content channel is provided by accessing an interstitial item displayed during an execution of the application.

4. The method of claim 1, wherein the user request to access the content channel is provided by accessing a notification provided through a push notification service of the mobile device.

5. The method of claim 1, wherein the content provided through the content channel is chosen based on one or more content customization parameters, the one or more content customization parameters include:
a description of the application;
a type of the application;
a category of the application;
a description chosen by an application developer;
a type of the application chosen by the application developer; or
a category chosen by the application developer.

6. The method of claim 5, wherein gathering the content using content channel SDK further includes:
generating a content request to retrieve the content from a content server, the content request including one or more content customization parameters;
receiving the content from the content server, the received content being associated with the one or more content customization parameters; and
organizing the received content according to a content layout utilized to organize the content by one or more content categories.

7. The method of claim 6, wherein the content categories includes one or more of:
a news;
a video;
a coupon;
a widget;
an application;
a featured article; or
an interactive poll question.

8. The method of claim 4, wherein the notification provided through the push notification service includes content that is compliant with a usage terms of the push notification service.

9. The method of claim 6, further comprising:
measuring user engagement with the content displayed through the content channel; and
reporting the measured user engagement to the content server.

10. The method of claim 6, wherein the user engagement is measured as a function of a length of time a given user has interacted with a given content displayed on a given mobile device.

11. A method for providing content through a mobile device, the method comprising:
receiving, by a content server, a request for content from a content channel Software Development Kit (SDK) embedded within an application, the request including one or more content customization parameters, wherein the application is executing on the mobile device;
gathering, by the content server, the requested content, wherein the requested content is associated with at least one of the one or more content customization parameters; and
sending, by the content server, the gathered content to the mobile device, wherein the content being sent is to be received by the content channel SDK on the mobile device, wherein the content channel SDK is configured to display any received content through a content channel associated with the content channel SDK.

12. The method of claim 11, wherein the request for content from the content channel SDK is provided by accessing a menu item within a menu of the application.

13. The method of claim 11, wherein the request for content from the content channel SDK is provided by accessing an interstitial item displayed during an execution of the application.

14. The method of claim 11, wherein the request for content from the content channel SDK is provided by accessing a notification provided through a push notification service of the mobile device.

15. The method of claim 11, wherein the content provided through the content channel is chosen based on the one or more content customization parameters, the one or more content customization parameters include:
a description of the application;
a type of the application;
a category of the application;
a description chosen by an application developer;
a type chosen by the application developer; or
a category chosen by the application developer.

16. The method of claim 15, wherein gathering the content further includes:
searching a content repository for content associated with the one or more content customization parameters, the content repository being managed by the content server;
searching a branded content repository for content associated with the one or more content customization parameters, the branded content repository including content from one or more third party content providers; and
identifying content from the content repository and the branded content repository, the identified content being associated with the one or more content customization parameters, the identified content including content from one or more content categories.

17. The method of claim 16, wherein the content categories includes one or more of:
a news;
a video;
a coupon;
a widget;
an application;
a featured article; or
an interactive poll question.

18. The method of claim 14, wherein the notification provided through the push notification service includes content that is compliant with the usage terms of the push notification service.

19. The method of claim 16, further comprising:
receiving, by the content server, a user engagement measurement from the mobile device, the user engagement measurement being measured by the content channel SDK for the content displayed through the content channel; and
aggregating, by the content server, the received user engagement measurement; and
storing, by the content server, the aggregated user engagement measurement.

20. The method of claim 16, wherein the user engagement is measured as a function of a length of time a given user has interacted with a given content displayed on a given mobile device.

21. A system, comprising:
at least one memory storing computer-executable instructions; and
at least one processor configured to access the at least one memory and execute the computer-executable instructions to perform a set of acts, the acts including:
receiving a user request to access a content channel associated with a content channel Software Development Kit (SDK), the content channel SDK being embedded within an application executing on the mobile device;
gathering, using the content channel SDK, the content to be provided through the content channel; and
displaying the gathered content through the content channel on the mobile device.

22. The system of claim 21, wherein the user request to access the content channel is provided by accessing a menu item within a menu of the application.

23. The system of claim 21, wherein the user request to access the content channel is provided by accessing an interstitial item displayed during an execution of the application.

24. The system of claim 21, wherein the user request to access the content channel is provided by accessing a notification provided through a push notification service of the mobile device.

25. The system of claim 21, wherein the content provided through the content channel is chosen based on one or more content customization parameters, the one or more content customization parameters include:
a description of the application;
a type of the application;
a category of the application;
a description chosen by an application developer;
a type chosen by the application developer; or
a category chosen by the application developer.

26. The system of claim 25, wherein gathering the content using content channel SDK further includes:
generating a content request to retrieve the content from a content server, the content request including one or more content customization parameters;
receiving the content from the content server, the received content being associated with the one or more content customization parameters; and
organizing the received content according to a content layout utilized to organize the content by one or more content categories.

27. The system of claim 26, wherein the content categories includes one or more of:
a news;
a video;
a coupon;
a widget;
an application;
a featured article; or
an interactive poll question.

28. The system of claim 24, wherein the notification provided through the push notification service includes content that is compliant with the usage terms of the push notification service.

29. The system of claim 26, further comprising:
measuring user engagement with the content displayed through the content channel; and
reporting the measured user engagement to the content server.

30. The system of claim 26, wherein the user engagement is measured as a function of a length of time a given user has interacted with a given content displayed on a given mobile device.
